(19) United States
(12) Patent Application Publication
(10) Pub. No.: US 2009/0166290 A1
(43) Pub. Date: Jul. 2, 2009

(54) AUTOMATED LOW VOLUME CROSSFLOW FILTRATION

(75) Inventor: Lars Andersson, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE HEALTHCARE BIO-SCIENCES AB, Uppsala (SE)

(21) Appl. No.: 12/282,893

(22) PCT Filed: Mar. 23, 2007
(86) PCT No.: PCT/EP2007/002588

§ 371 Date: Sep. 15, 2008

(30) Foreign Application Priority Data
Mar. 28, 2006 (GB) 0606144.4

(51) Int. Cl. B01D 65/02; B01D 61/32; G05B 19/00; G05D 7/00

(52) U.S. Cl. 210/636; 210/137; 700/282

(57) ABSTRACT

The invention provides an automated crossflow filtration method and system for separating a component of interest from one or more other components in a solution. The invention is of particular use in the field of protein separations and concentration, where specific proteins must be separated and purified from cell lysates and cultures. The system may be under the control of a computer software programme.

### CROSS-REFERENCE TO RELATED APPLICATIONS

This application is a filing under 35 U.S.C. § 371 and claims priority to international patent application number PCT/EP2007/002588 filed Mar. 23, 2007, published on Oct. 4, 2007, as WO 2007/110203, which claims priority to patent application number 0606144.4 filed in Great Britain on Mar. 28, 2006.

### FIELD OF THE INVENTION

The present invention relates to an automated crossflow filtration method and system for separating a component of interest from one or more other components in a solution. The invention is of use in the field of protein separations, where specific proteins must be separated and purified from cell lysates and cultures. The invention finds particular utility in concentrating proteins which are present at low concentrations in a solution containing one or more components.

### BACKGROUND OF THE INVENTION

Separation of target molecules is of great commercial interest in the chemical and biotechnological fields, such as the production of novel biological drugs and diagnostic reagents. Furthermore, the isolation and purification of proteins is of great significance due to advances in the field of proteomics, wherein the function of proteins expressed by the human genome is studied. Proteins of interest are often present at very low concentrations within a biological sample and so it is very important to develop isolation and separation techniques which can handle low volumes of such samples with minimal wastage. This is particularly true in research laboratories which are concerned with the early stage purification and characterisation of proteins which are present in low concentrations of source material.

In general, proteins are produced in cell culture, where they are either located intracellularly or secreted into the surrounding culture media. Since the cell lines used are living organisms, they must be fed with a complex growth medium, containing sugars, amino acids, growth factors, etc. Separation and purification of a desired protein from the complex mixture of nutrients and cellular by-products, to a level sufficient for characterisation, poses a formidable challenge.

Semi-permeable membrane filtration is often used in the purification of proteins, microfiltration and ultrafiltration being the most commonly practised techniques. Microfiltration membranes exhibit permselective pores ranging in diameter from between 0.01 and 10 μm. Micro-filtration is defined as a low pressure membrane filtration process which removes suspended solids and colloids generally larger than 0.1 μm in diameter. Such processes can be used to separate particles or microbes that can be seen with the aid of a microscope such as cells, macrophage, large virus particles and cellular debris.

Ultra-filtration membranes are characterized by pore sizes which enable them to retain macromolecules having a molecular weight ranging between 500 and 1,000,000 daltons, and thus are often used for concentrating proteins. Ultra-filtration is a low-pressure membrane filtration process which separates solutes up to 0.1 μm in size. Thus, for example, a solute of molecular size significantly greater than that of the solvent molecule can be removed from the solvent by the application of a hydraulic pressure, which forces only the solvent to flow through a suitable membrane (usually one having a pore size in the range of 0.001 to 0.1 μm). Ultra-filtration is capable of removing bacteria and viruses from a solution.

Many automated systems exist for the separation of proteins using such ultra- and microfiltration membranes (e.g. GE Healthcare Life Sciences, Uppsala, Sweden).

Crossflow filtration (sometimes referred to a ‘tangential flow filtration’) systems are widely used in industry; typical examples include manufacturing process separations, waste treatment plants and water purification systems where they extend the lifetime of filtration membranes by removing and preventing the build up of contaminants (e.g. WO 2005/081627) and promote consistency of the filtration process with time.

The most commonly used crossflow membrane processes are microfiltration and ultrafiltration. These processes are pressure driven and depend upon the ‘membrane flux’, defined as the flow volume over time per unit area of membrane, across the microfiltration or ultrafiltration membrane. At low pressures, the transmembrane flux is proportional to pressure. Thus by varying the transmembrane pressure difference driving force and average pore diameter, the membrane may serve as a selective barrier by permitting certain components of a mixture to pass through while retaining others. This results in two phases, the permeate and retentate phases, each of which is enriched in one or more of the components of the mixture.

Crossflow filtration systems are commercially available from a number of manufacturers for a range of applications, including the separation of biological materials (e.g. GE Infrastructure, Water and Process Technologies, Fairfield, Conn., USA; Millipore, Billerica, M, USA; SciLog, Wis., USA; GEA filtration, MG Technologies, Frankfurt, Germany).

However, one major disadvantage of existing systems which are used to purify biological materials is that they require relatively large volumes of sample (typically >25 mls), due to the internal configuration of the pumps, and have significant ‘dead volumes’. This can be extremely wasteful of material which, in the case of proteins which are often only present in relatively low concentrations in biological samples, can be very expensive and resource consuming.

Another disadvantage associated with conventional crossflow systems is that of foaming, caused by air within the system, which also leads to losses of material.

U.S. Pat. No. 5,935,437 describes a single-use, manually operated crossflow filtration system for preparing plasma samples from patients' blood during surgery. The system disclosed is capable of handling a small volume (e.g. less than 10 ml of blood) under aseptic conditions. While this system is clearly suitable for use in an operating theatre, it is not suitable for use in a research or industrial laboratory where users require automated systems which are robust, reliable, environmentally regulated and precise.

Spectrum Labs (Spectrum Laboratories Inc., USA) provide the components for making a simple cross flow separation system for use in processing small volumes of samples containing biological materials. The disposable MICROKROS® modules comprise hollow fibre membranes in a polysulfone housing. These modules can be operated manually using conventional syringes to handle volumes as low as 2 ml of sample. Alternatively, the modules can be used with a peristaltic pump, such as the Spectrum MICROKROS® System, to process sample volumes ranging from 10 to 200 ml. Although this system can accommodate small volumes of solution (i.e. from 10 to 200 ml), the precision of separation can be variable as the system is controlled by a peristaltic pump.

There is therefore a need within the research communities of the chemical and biotechnological industries for an automated crossflow filtration system which can handle small volumes of solution, under carefully regulated conditions, with a high level of precision and minimal wastage of sample. Further cost savings could be achieved if it were possible to wash and reuse the membranes employed in such a system.

The present invention addresses these problems and provides a method and system for separating a first component of interest from one or more components in a solution. To improve consistency and efficiency, the system of the invention may be under the control of a computer software programme.

### SUMMARY OF THE INVENTION

In a first aspect of the invention, there is provided an automated crossflow filtration method for separating a component of interest from one or more other components in 50 ml or less of a solution comprising the steps of
i) transferring said solution from a sample container into a receiving chamber of a first pump, said chamber being in fluid communication via one or more flow-directing valves with a receiving chamber of a second pump, wherein both said chambers have a moveable wall for altering the volume of the chamber;
ii) passing the solution through a filter unit, said filter unit comprising
   i. a first inlet and a second inlet in fluid communication with each other
   ii. an outlet
   iii. a filtration membrane separating the inlets from the outlet, by simultaneously driving the solution from the chamber of the first pump through the filtration membrane and aspirating the first retentate produced into the chamber of said second pump;
iii) collecting the first permeate produced which has passed through the filtration membrane;
iv) reversing the direction of flow across the filtration membrane by simultaneously driving the first retentate from the chamber of the second pump back through the filter unit and the filtration membrane and aspirating the second retentate produced into the chamber of the first pump;
v) collecting the second permeate produced and/or the second retentate;
   wherein a predetermined membrane flux or pressure is maintained across the filtration membrane by controlling the differential rate of movement of the wall in the first and second receiving chamber of the first and second pump.

A component of interest may be chemical compound, or a biological entity or a biological molecule. Examples of chemical compounds include naturally occurring and synthetic compounds such as drugs and therapeutic agents. Biological entities include, for instance, cells (e.g. blood cells and animal cells), microbes (e.g. bacteria and fungi), and sub-cellular particles (e.g. mitochondria, viruses etc). Biological molecules may include proteins, peptides, polynucleotides, and polysaccharides. The method is of particular utility in separating proteins and in concentrating proteins which are present at low concentrations in a solution containing one or more components.

Membranes may include ultrafiltration membranes, affinity membranes (i.e. membranes which are derivitized to bind to ligands in a specific or non-specific manner), microfiltration membranes, ion exchange resins and reverse phase membranes. Such membranes are well known in the art and are available from a range of suppliers (e.g. GE Healthcare Life Sciences, Sweden; Sartorius AG; Germany; Meissner Inc., USA). The membranes may be of flat or hollow configuration.

A second aspect of the invention relates an automated crossflow filtration system for separating a component of interest from one or more other components in 50 ml or less of a solution comprising
i) a first pump having a receiving chamber and a moveable wall for altering the volume of said chamber, said moveable wall being operable by a first drive motor, the chamber being in fluid communication via a first flow-directing valve with a sample container and a first inlet of a filter unit;
ii) said filter unit comprising
   a. a first inlet and a second inlet in fluid communication with each other
   b. an outlet
   c. a filtration membrane separating the inlets from the outlet,
iii) the second inlet of the filter unit being in fluid communication via a second flow-directing valve with a receiving chamber of a second pump;
iv) said second pump comprising said receiving chamber and a moveable wall for altering the volume of the chamber, said moveable wall being operable by a second drive motor;
v) the first flow-directing valve comprising one or more ports enabling fluid communication of the chamber of the first pump with one or more containers for aspiration of solution therefrom and/or the collection of retentate therein; optionally, enabling the aspiration of buffer therefrom;
vi) the second flow-directing valve comprising one or more ports enabling fluid communication of the chamber of the second pump with a plurality of containers for aspiration of washing fluid therefrom and/or collection of retentate or waste therein;
   characterised in that a predetermined membrane flux or pressure is maintained across the filtration membrane by controlling the differential rate of movement of the wall in the first and second receiving chamber of the first and second pump.

A third aspect of the invention relates to a computer programme arranged to perform the method of the invention.

A fourth aspect of the invention relates to a data carrier in which the computer programme is stored.

Further features and advantages of the invention will become apparent from the following description of preferred embodiments of the invention, given by way of example only, which is made with reference to the accompanying drawings.

### BRIEF DESCRIPTION OF THE DRAWINGS

The transverse section in FIG. 1 shows one embodiment of the invention in which the crossflow filtration system has a series of filter units which each comprise a microfiltration membrane.

FIG. 2 depicts a transverse section of one embodiment of the invention in which the crossflow filtration system has a series of filter units which each comprise an ultrafiltration membrane.

FIG. 3 illustrates, in transverse section, an embodiment of the invention in which the crossflow filtration system has a filter unit containing a microfiltration membrane, a filter unit comprising an ultrafiltration membrane, and an affinity membrane.

### DETAILED DESCRIPTION OF THE INVENTION

One embodiment of an automated crossflow system 1 according to the invention, utilising a microfiltration membrane is shown in transverse section in FIG. 1. The system can be used to separate components present in a solution, such as are commonly found in biological samples. For example, depending upon the pore size of the membrane used, cells (such as blood cells) can be washed with buffers prior to lysis to remove contaminants, cellular debris can be separated from soluble materials, and/or proteins can be purified for characterisation.

The system 1 comprises a first pump 10 and second pump 20 which are in fluid connection with one another through one or more filter units 30, 40, 50, 60 connected through a first flow-directing valve 70 and a second flow directing valve 80. Each pump comprises a receiving chamber 12, 22 and a moveable wall 14, 24 connected through a drive shaft 16, 26 to independent drives 18, 28. A solution can be drawn into or expulsed from the receiving chamber 12, 22 by the axial movement of the wall 14, 24 relative to the body of the pump 10, 20 (e.g. in the direction of the arrow shown in FIG. 1) when the drive 18, 28 is activated. The walls of the receiving chamber 12, 22 are made of an inert material, such as glass, ceramics, stainless steel or an appropriate plastic polymer which can withstand high operational pressures and not react with any components within the solution.

In use, solutions 91, 92, 93, 94 which each comprise a component of interest and one or more other components, are sequentially aspirated from their respective sample containers into the receiving chamber 12 of the first pump 10 by movement of the wall 14 in the opposite direction to the arrow shown in the figure. The use of the system 1 will be described in relation to separating components of interest from a single solution 91 but it will be understood that the system can be used to sequentially separate components from other components within a plurality of solutions (e.g. from solutions 92, 93, 94).

The solution 91 is drawn from its sample container into the receiving chamber 12 of the first pump 10 via the flow directing valve 70 by means of tubing 71. The tubing 71 and valve 70 are made of conventional materials, such as metals or plastics, which do not react with any components in the solution. The valve 70, comprises one or more ports (not shown) which can be used to allow the valve 70 to act as a filter unit 30 selecting valve and/or an inlet/outlet valve.

In the first half of the cycle, solution 91 is driven from the receiving chamber 12 of the first pump 10, by movement of the wall 14 in the direction of the arrow shown in FIG. 1, through the valve 70 and into the filter unit 30 by means of tubing 76. The first pump 10 thus controls or regulates the flowrate of ‘feed’ solution 91 (i.e. the solution prior to filtration) moving into and through the filter unit 30.

The filter unit 30 comprises a first inlet 32 in fluid communication with a second inlet 34, the inlets being connected to the first and second flow-directing valves 70, 80, respectively, by inert tubing 76, 86. The inlets 32, 34 are separated from an outlet 36 by a membrane 38 within the filter unit 30 which is selectively permeable to the component of interest. The membrane 38 in FIG. 1 is a microfiltration membrane but it will be understood that, depending upon the nature of the separation to be effected, an ultrafiltration membrane could be used. A microfiltration membrane will be chosen which has pore sizes such that the component of interest within the solution will pass through the membrane whereas larger components will be retained by it. The solution passing through the membrane is known as the permeate, while the material retained by the membrane is called the retentate.

As described above and shown in FIG. 1, the second pump 20 is in fluid communication with the first pump 10 by means of the first and second flow-directing valves 70, 80. The pumps 10, 20 are independently driven such that the receiving chamber 12 of the first pump 10 empties at a faster rate than the receiving chamber 22 of the second pump 20 fills. The higher speed of the wall 14 in emptying the first chamber 12 compared to the speed of the wall 24 in filling the second chamber 22 creates a permeate flux across the membrane 38. Thus the permeate flux, which determines the rate of separation of components across the membrane, is controlled by the differential speed of the walls 14, 24 of the first 12 and second 22 receiving chambers. This permeate flux may be monitored by pressure sensors 101, 103. Other sensors (102, 104, 105) may be employed to monitor other physical parameters (e.g. temperature, conductivity, pH, oxygen concentration, ultraviolet light absorption) within the system.

In the embodiment shown in FIG. 1, the filter unit 30 contains a microfiltration membrane 38 and permeate passing through the membrane 38 is collected from the outlet 36 as product 111. The retentate is collected in the receiving chamber 22 of the second pump 20.

When the wall 14 reaches the end position of the stroke in emptying the solution 91 from the chamber 12, the first half of the cycle is complete and the movement of both drives 18, 28 is reversed. In this half of the cycle, the ‘feed control’ pump (initially the first pump 10 in the first half of the cycle) becomes the retentate control pump and the retentate control pump (the second pump 20 in the first half of the cycle) becomes the feed control pump. The direction of flow is thus reversed such that retentate is driven from the second receiving chamber 22 back into the filter unit 30 and across the membrane 38 to further remove components of interest from the retentate. Once again, the slower speed of filling the retentate control pump (first pump 10 in this phase of the cycle) relative to the speed of emptying the feed control pump (i.e. second pump 20) creates a permeate flux across the membrane 38. The permeate passing through the membrane 38 is collected as further product 111 and the resulting retentate aspirated into the first receiving chamber 12. In this way, components of interest are sequentially removed from the solution 91. The cycle can be repeated, either using the same retentate or by aspirating fresh solution 91 into the first chamber 12 (or second chamber 22) to maintain the volume of solution within the system by means of the flow-directing valve 70, 80 at the start of each new stroke. By replenishing the system with fresh solution 91, 121 in this way, the system is not limited to simply processing volumes equivalent to the volume of the receiving chamber 12, 22. At the end of a complete cycle, waste materials can be removed from the system via the second flow-directing valve 80 as waste 124.

By means of the flow-directing valves (e.g. 80) equipped with inlet/outlet ports, the membrane 38 can be cleaned with washing fluid/buffers 122, 123 at the end of a complete cycle to remove any contaminants (such as solids, particles, etc) which adsorb to the membrane surface and block the pores. In this way, the operational lifetime of the membrane can be increased and its efficiency maintained.

It will be understood by the person skilled in the art that other samples 92, 93, 94 can be sequentially filtered in a similar manner either through the same filter unit 30 or different filter units 40, 50, 60 which either contain the same or different membranes (e.g. one having a different pore size). Following filtration in the filter units 40, 50, 60, permeate can be collected from outlets (see shorter arrows) as product 112, 113 and 114. It will also be understood that the system can be used in combination with ultrafiltration membranes, as described below.

All materials used in the construction of the system which come into contact with the solution, retentate and/or permeate are selected to avoid any chemical interaction and to minimise physical adsorption with the components within the solution. Typically, the walls of the receiving chamber and the valves are made of glass, ceramics or stainless steel and the tubing of an inert plastic polymer.

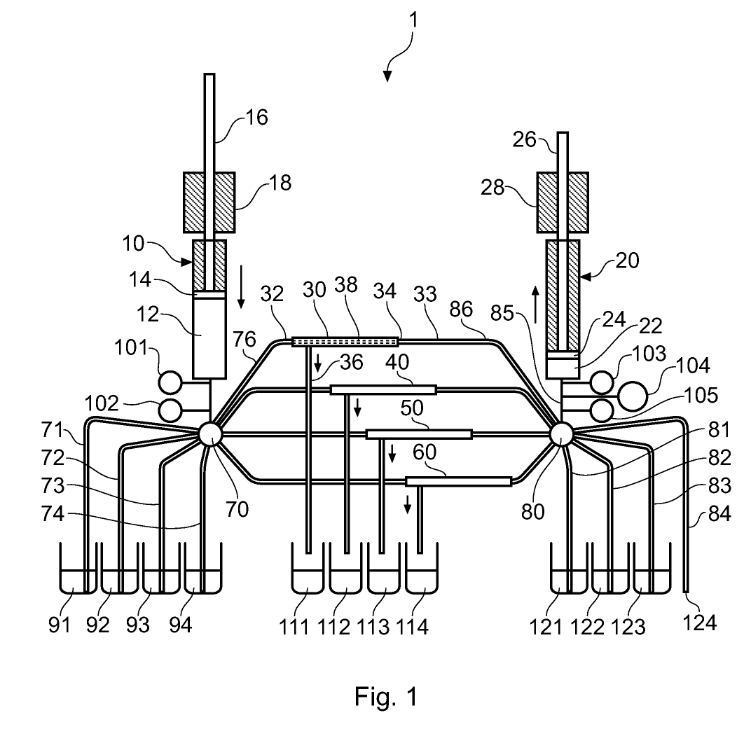

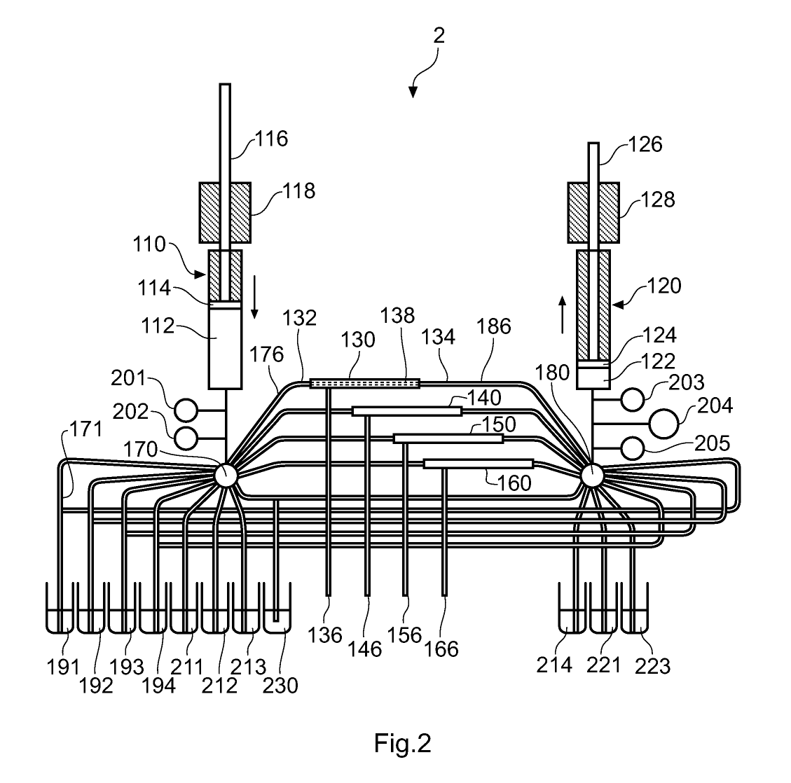

FIG. 2 is a transverse section showing a second embodiment of an automated crossflow system 2 according to the invention. This embodiment can be used to ultrafiltrate samples, for example, the system can be used to concentrate particular components present in a sample, such as proteins, for further characterisation.

The system 2 has a similar configuration to that described in FIG. 1 above. Thus a first pump 110 and second pump 120 are in fluid connection with one another through one or more filter units 130, 140, 150, 160 connected through a first and second flow-directing valve 170, 180. Each pump comprises a receiving chamber 112, 122 and a moveable wall 114, 124 connected through a drive shaft 116, 126 to independent drives 118, 128. A solution 191 can be drawn into or expulsed from the receiving chamber 112, 122 by the axial movement of the wall 114, 124 relative to the body of the pump 110, 120 (e.g. in the direction of the arrow shown in FIG. 2) when the drive 118, 128 is activated. The walls of the receiving chamber 12, 22 are made of an inert material, such as glass, ceramics, stainless steel or an appropriate plastic polymer which can withstand high operational pressures and not react with any components within the solution.

In use, solutions 191, 192, 193, 194 (which each comprise a component of interest in mixture with other components) are sequentially aspirated from their respective sample containers into the receiving chamber 112 of the first pump 110 by movement of the wall 114 in the opposite direction to the arrow shown in the figure. The use of the system 2 will be described in relation to separating components of interest from a single solution 191 but it will be understood that the system can be used sequentially to separate components from other components within a plurality of solutions (e.g. from solutions 192, 193, 194). In the present example, the solution 191 contains a protein of interest which is to be separated from other components present in the solution and concentrated by ultrafiltration.

As described in FIG. 1 above, the first step in the process is for the solution 191 to be drawn from its sample container into the receiving chamber 112 of the first pump 110 via the flow directing valve 170 by means of tubing 171. The tubing 171 and valve 170 are made of conventional materials, such as metals or plastics, which do not react with any components in the solution. The valve 170, comprises one or more ports (not shown) which can be used to allow the valve 170 to act as a filter unit 130 selecting valve and/or an inlet/outlet valve.

In the first half of the cycle, solution 191 is driven from the receiving chamber 112 of the first pump 110, by movement of the wall 114 in the direction of the arrow shown in FIG. 2, through the valve 170 and into the filter unit 130 via tubing 176. The first pump 110 thus controls or regulates the flowrate of ‘feed’ solution 191 (i.e. the solution prior to filtration) moving into and through the filter unit 130.

The filter unit 130 comprises a first inlet 132 in fluid communication with a second inlet 134, the inlets being connected to the first and second flow-directing valves 170, 180, respectively, by inert tubing 176, 186. The inlets 132, 134 are separated from an outlet 231 by a membrane 138 which is selectively impermeable to the component of interest. An ultrafiltration membrane will be chosen which has pore sizes such that the component of interest within the solution (in this case a protein) will be retained by the membrane (i.e. the retentate) whereas smaller components will pass through it (i.e. the permeate). The membrane may be hollow or flat in configuration; in the example shown a hollow membrane is used such that permeate passing through the membrane may then be expulsed from the system through outlet 136 as waste.

As shown in FIG. 2, the second pump 120 is in fluid communication with the first pump 110 by means of the first and second flow-directing valves 170, 180. The pumps 110, 120 are independently driven such that the receiving chamber 112 of the first pump 110 empties at a faster rate than the receiving chamber 122 of the second pump 120 fills. The higher speed of the wall 114 in emptying the first chamber 112 compared to the speed of the wall 124 in filling the second chamber 122 creates a pressure difference across the membrane 138. This pressure difference determines the rate of separation of components across the membrane and is controlled by the differential speed of the walls 114, 124 of the first 112 and second 122 receiving chambers. This pressure difference is monitored by pressure sensors 201, 203. Other sensors (202, 204, 205) may be employed to monitor other physical parameters (e.g. temperature, conductivity, pH, oxygen concentration, ultraviolet light absorption) within the system.

In the embodiment shown in FIG. 2, the retentate following filtration is collected in the receiving chamber 122 of the second pump 120 and the permeate passing through the membrane 138 is discarded from the outlet 136 as waste.

When the wall 114 reaches the end position of the stroke in emptying the solution 191 from the chamber 112, the first half of the cycle is complete and the movement of both drives 118, 128 is reversed. In this half of the cycle, the ‘feed control’ pump (initially the first pump 10 in the first half of the cycle) becomes the retentate control pump and the retentate control pump (the second pump 120 in the first half of the cycle) becomes the feed control pump. The direction of flow is thus reversed such that retentate is driven from the second receiving chamber 122 back into the filter unit 130 and across the membrane 138 to further remove contaminating components from the retentate. Once again, the slower speed of filling the retentate control pump (first pump 110 in this phase of the cycle) relative to the speed of emptying the feed control pump (i.e. second pump 120) creates a pressure differential across the membrane 138. The resulting retentate is aspirated into the first receiving chamber 112. Permeate containing low molecular weight components passing through the membrane 138 is discarded as waste from outlet 136.

In this way, contaminating components are sequentially removed from the solution 191 and the component of interest (e.g. a protein) is concentrated in the retentate. The retentate can be collected as product 211 at the end of the cycle.

The cycle can be repeated, either using the same retentate, or by aspirating fresh solution 191 into the first chamber 112 (or second chamber 122) to maintain the volume of solution within the system by means of the flow-directing valve 170, 180 at the start of each new stroke. By replenishing the system with fresh solution 191 in this way, the system is not limited to simply processing volumes equivalent to the volume of the receiving chamber 112, 122. At the end of a complete cycle, the retentate is collected as product 211 and low molecular weight contaminating components are effluxed from the system via outlet 136.

It will be understood that if diafiltration is desired, the retentate can be diluted with dialysis buffer at the end of either or both halves of the cycle by the addition of the appropriate buffer solution 230 into either or both receiving chambers 112, 122 to maintain a constant sample volume. The retentate can thus be washed with buffer 230 at a suitable pH and/or having an appropriate ionic strength, either once or repeatedly, to ensure removal of low molecular weight contaminants. The resulting retentate can be collected as product 211 and can be further diluted, if required, in the dialysis buffer ready for characterisation.

Following the final collection of retentate as product 211, the membrane 138 can be cleaned with washing fluid/buffers 221, 223 at the end of a complete cycle to remove any contaminants (such as solids, particles, etc) which adsorb to the membrane surface and block the pores. In this way, the operational lifetime of the membrane can be increased and its efficiency maintained.

All materials used in the construction of the system which come into contact with the solution, retentate and/or permeate are selected to avoid any chemical interaction and to minimise physical adsorption with the components within the solution. Typically, the walls of the receiving chamber and valves are made of glass, ceramics or stainless steel and the tubing of an inert plastic polymer.

It will be understood by the person skilled in the art that other samples 192, 193, 194 can be sequentially filtered in a similar manner either through the same filter unit 130 or different filter units 140, 150, 160 which either contain the same or different membranes (e.g. microfiltration membranes having different pore sizes). Following filtration in the filter units 140, 150, 160, retentate can be collected from the outlets (see shorter arrows) as product 212, 213 and 214.

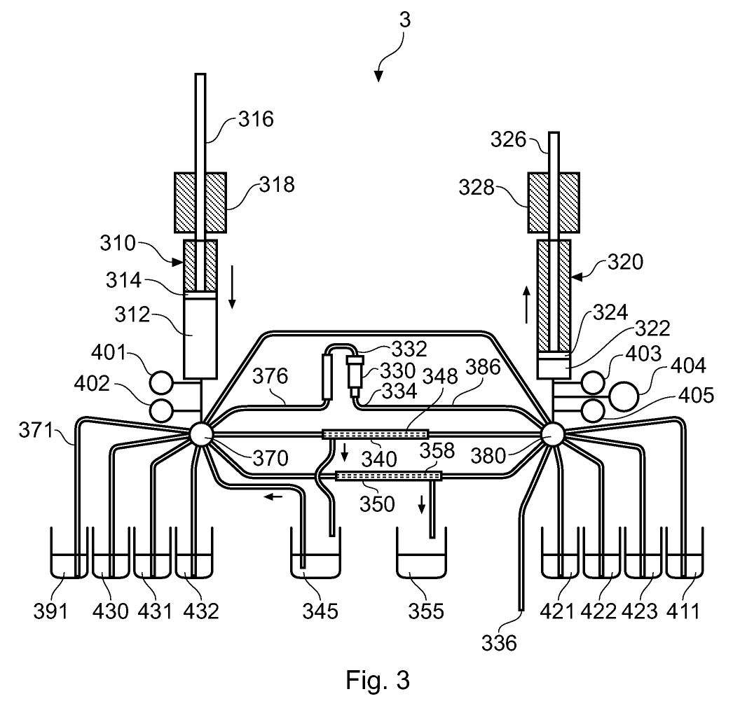

The skilled person will also understand that other forms of separation membranes can be used in the system and method of the invention, either alone or in combination. Thus, for example, the system can be used to separate components on interest on the basis of size, charge, chirality by selection of the appropriate membrane. A combination of different types of membranes (e.g. ultrafiltration, microfiltration, affinity membranes, reverse phase membranes, ion exchange membranes, hydrophobic membranes) can be employed in the system, as illustrated in the embodiment depicted in FIG. 3. The transverse section in FIG. 3 shows a system according to the invention utilising three different forms of separation—i.e. affinity chromatography, ultrafiltration and microfiltration. Such a system is particularly suitable for the separation of proteins from biological samples.

The system 3 has a similar configuration to that described in FIGS. 1 and 2 above and operates in a similar manner. A first pump 310 and second pump 320 are in fluid connection with one another through one or more filter units 330, 340, 350 connected through a first and second flow-directing valve 370, 380. Filter unit 330 contains an affinity membrane (not shown), unit 340 a microfiltration membrane 348 and unit 350 an ultrafiltration membrane 358.

Each pump comprises a receiving chamber 312, 322 and a moveable wall 314, 324 connected through a drive shaft 316, 326 to independent drives 318, 328. A solution 391 can be drawn into or expulsed from the receiving chamber 312, 322 by the axial movement of the wall 314, 324 relative to the body of the pump 310, 320 when the drive 318, 328 is activated. The walls of the receiving chamber 312, 322 are made of an inert material, such as glass, ceramics, stainless steel or an appropriate plastic polymer which can withstand high operational pressures and not react with any components within the solution.

In the example shown, the solution 391 contains a protein of interest which is to be separated from other components present in the solution by affinity chromatography and microfiltration, followed by washing and diafiltration.

Solution 391, which comprises a protein of interest in mixture with other components, is aspirated from its container into the receiving chamber 312 of the first pump 310 via tubing 371 and valve 370 by the upward movement of the wall 314 (i.e. in the opposite direction to the arrow shown in FIG. 3). The tubing 371 and valve 370 are made of conventional materials, such as metals or plastics, which do not react with any components in the solution. The valve 370, comprises one or more ports (not shown) which can be used to allow the valve 370 to act as a filter unit 330 selecting valve and/or an inlet/outlet valve.

In the first half of the affinity separation cycle, solution 391 is driven from the receiving chamber 312 of the first pump 310, by movement of the wall 314 in the direction of the arrow shown in FIG. 3, through the valve 370 and into the filter unit 330 (via tubing 376). As described in FIGS. 1 and 2 above, the first pump 310 controls or regulates the flowrate of ‘feed’ solution 391 (i.e. the solution prior to filtration) moving into and through the filter unit 330.

The filter unit 330 comprises a first inlet 332 in fluid communication with an outlet 334, the inlet and outlet being connected to the first and second flow-directing valves 370, 380, respectively, by inert tubing 376, 386. The inlet 332 is separated from the outlet 334 by an affinity membrane (not shown) to which the protein of interest in the solution selectively binds. Affinity membranes are well known in the art (see for example ‘Affinity Membranes: Their Chemistry and Performance in Adsorptive Separation Processes’, E Klein, 1991) and are commercially available from a number of suppliers (e.g. GE Healthcare Life Sciences). An affinity membrane will be chosen or prepared such that the protein of interest is bound to the membrane while other components in the sample pass through the membrane and are collected in the receiving chamber 322. The contents of the receiving chamber 322 are then discarded as waste 336 in the second half of the cycle following reversal of the flow (as described in FIGS. 1 and 2 above).

Bound protein is released from the affinity membrane in the second cycle by washing with an appropriate affinity buffer 431 and collecting the protein-enriched fraction in the receiving chamber 322 (the process may be repeated using an additional affinity buffer 432 as required to ensure complete removal of the protein from the affinity membrane). This fraction may be purified by passage across microfiltration membrane 348 in the second half of the cycle, to remove any high molecular weight contaminants, the resulting permeate 345 being collected.

The permeate 345 can then be concentrated further or subjected to diafiltration by passage across ultrafiltration membrane 358 in a third cycle. If diafiltration is desired, the permeate 345 is diluted with a dialysis buffer 430 and the retentate obtained by passage across the membrane in the first half of the cycle is collected as product 411, either directly or following further dilution with dialysis buffer 430, the permeate being discarded as waste 355. Alternatively, the retentate may be purified still further by reversing the direction of flow across the ultrafiltration membrane 358 (as described in FIGS. 1 and 2 above) to remove any remaining low molecular weight components and collecting the retentate in the first receiving chamber 312 (the permeate from the ultrafiltration being discarded as waste 355). The retenate can then be collected directly as product 411 by expulsion from chamber 312 (via valves 370/380) or diluted further with diafiltration buffer 430 prior to collection as product 411 (via valves 370/380).

If the user simply wishes to concentrate the protein, then the permeate 345 is subjected to the ultrafiltration steps described above without the addition of the diafiltration buffer 430. The retentate produced is then collected as product 411.

Washing fluids 421, 422, 423 can be used to clean the membranes and filter units 330, 340, 350 at the end of a complete cycle.

It will be understood that the skilled person may wish to carry out variations in the separation process described in FIG. 3 above. Thus, for example, it is possible to carry out the same process but in a different sequence (e.g. microfiltration first, followed by ultrafiltration/diafiltration and then affinity separation). Such variations are clearly possible, the order in which each of the separation steps are conducted depending upon the objective of the skilled person.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An automated crossflow filtration method for separating a component of interest from one or more other components in 50 ml or less of a solution comprising the steps of:
i) transferring said solution from a sample container into a receiving chamber of a first pump, said chamber being in fluid communication via one or more flow-directing valves with a receiving chamber of a second pump, wherein both said chambers have a moveable wall for altering the volume of the chamber;
ii) passing the solution through a filter unit, said filter unit comprising
i. a first inlet and a second inlet in fluid communication with each other
ii. an outlet
iii. a filtration membrane separating the inlets from the outlet,
b. by simultaneously driving the solution from the chamber of the first pump through the filtration membrane and aspirating the first retentate produced into the chamber of said second pump;
iii) collecting the first permeate produced which has passed through the filtration membrane;
iv) reversing the direction of flow across the filtration membrane by simultaneously driving the first retentate from the chamber of the second pump back through the filter unit and the filtration membrane and aspirating the second retentate produced into the chamber of the first pump;
v) collecting the second permeate produced and/or the second retentate;
wherein a predetermined membrane flux or pressure is maintained across the filtration membrane by controlling the differential rate of movement of the wall in the first and second receiving chamber of the first and second pump.

2. The method of claim 1, further comprising the step of repeating steps ii) to v) to further increase the separation of the first and second component in the solution.

3. The method of claim 1, wherein the volume of sample is in the range of 1 ml to 10 ml.

4. The method of claim 3, further comprising the step of transferring additional solution from said sample container into the receiving chamber of the first pump following step v).

5. The method of claim 4, wherein the rate of movement of the moveable wall in either the first or second receiving chamber in driving solution or retentate from the chamber is greater than its rate of movement in aspirating the retentate.

6. The method of claim 5, wherein the filtration membrane is selected from the group consisting of microfiltration membrane, ultrafiltration membrane, affinity membrane, reverse phase membrane and ion exchange membrane.

7. The method of claim 6, wherein the membrane is a microfiltration membrane having a pore size of 0.1 to 10 μm.

8. The method of claim 6, wherein the permeate contains the component of interest.

9. The method of claim 6, wherein the filtration membrane is an ultrafiltration membrane having a pore size of 0.001 to 0.1 μm.

10. The method of claim 6, wherein the retentate contains the component of interest.

11. The method of claim 10, wherein the component of interest is selected from the group consisting of chemical compound, biological entity and biologically active molecule.

12. The method of claim 11, wherein the biological entity is a cell.

13. The method of claim 11, wherein the biologically active molecule is a protein.

14. The method of claim 13, wherein the solution is a cell lysate, cell extract or cell culture.

15. The method of claim 14, wherein a plurality of different solutions are filtered sequentially by use of a plurality of filter units connected in parallel to the first and second pump.

16. The method of claim 15, wherein the different filter units comprise one or more membranes selected from the group consisting of microfiltration membrane, ultrafiltration membrane, affinity membrane, reverse phase membrane and ion exchange membrane.

17. The method of claim 8, wherein the permeate is additionally filtered through an ultrafiltration membrane to produce a retentate.

18. The method of claim 8, wherein the permeate is passed through an affinity membrane.

19. An automated crossflow filtration system for separating a component of interest from one or more other components in 50 ml or less of a solution comprising:
i) a first pump having a receiving chamber and a moveable wall for altering the volume of said chamber, said moveable wall being operable by a first drive motor, the chamber being in fluid communication via a first flow-directing valve with a sample container and a first inlet of a filter unit;
ii) said filter unit comprising
a. a first inlet and a second inlet in fluid communication with each other
b. an outlet
c. a filtration membrane separating the inlets from the outlet,
iii) the second inlet of the filter unit being in fluid communication via a second flow-directing valve with a receiving chamber of a second pump;
iv) said second pump comprising said receiving chamber and a moveable wall for altering the volume of the chamber, said moveable wall being operable by a second drive motor;
v) the first flow-directing valve comprising one or more ports enabling fluid communication of the chamber of the first pump with one or more containers for aspiration of solution therefrom and/or the collection of retentate therein; optionally, enabling the aspiration of buffer therefrom;
vi) the second flow-directing valve comprising one or more ports enabling fluid communication of the chamber of the second pump with a plurality of containers for aspiration of washing fluid therefrom and/or collection of retentate or waste therein;
wherein a predetermined membrane flux or pressure is maintained across the filtration membrane by controlling the differential rate of movement of the wall in the first and second receiving chamber of the first and second pump.

20. The system of claim 19, further comprising one or more containers for buffer or retentate in fluid communication with the first and/or second flow directing valve.

21. The system of claim 19, further comprising one or more sensors for monitoring environmental and/or chemical conditions of the solution or retentate.

22. The system of claim 21, wherein said sensor is selected from the group consisting of pH sensor, pressure sensor, oxygen level sensor and conductivity sensor.

23. The system of claim 19, wherein the membrane is selected from the group consisting of microfiltration membrane, ultrafiltration membrane, affinity membrane, reverse phase membrane and ion exchange membrane.

24. The system of claim 19, further comprising a plurality of filter units connected in parallel to the first and second pump.

25. The system of claim 24, wherein said different filter units each comprise a membrane selected from the group consisting of microfiltration membrane, ultrafiltration membrane, affinity membrane and ion exchange membrane.

26. The system of claim 25, wherein the membrane of the filter unit is a microfiltration membrane, further comprising:
i) a second filter unit comprising an ultrafiltration membrane; and
ii) a third filter unit comprising an affinity membrane.

27. A computer software arranged to perform the method of claim 1.

28. (canceled)
